(19) United States
(12) Patent Application Publication
(10) Pub. No.: US 2010/0200344 A1
(43) Pub. Date: Aug. 12, 2010

(54) Apparatus for damping the torsional excitation of a hollow drive shaft

(76) Inventor: Grahame Knowles, Lincoln (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/679,944

(22) PCT Filed: Sep. 3, 2008
(86) PCT No.: PCT/EP08/61588

§ 371 Date: Mar. 25, 2010

(30) Foreign Application Priority Data
Sep. 27, 2007 (GB) 0718861.8

(51) Int. Cl. F16F 15/16

(52) U.S. Cl. 188/290

(57) ABSTRACT

An apparatus for damping the torsional excitation of a hollow drive shaft is provided. The apparatus includes an elongate member that extends along the interior of the drive shaft, one end of the member is secured to one end of the drive shaft, the other end of the member is disposed at the other end of the drive shaft, and a hydraulic damping device secured to the other end of the drive shaft for damping vibration of the other end of the member. The hydraulic damping device includes a piston and cylinder arrangement having first and second hydraulic chambers, a reservoir of hydraulic fluids, and hydraulic circuitry which uses the hydraulic chambers to communicate with the reservoir. The hydraulic damping device is arranged so that any leakage of hydraulic fluid from the first and second hydraulic chambers via a piston/cylinder interface passes to the reservoir of hydraulic fluid.

### CROSS REFERENCE TO RELATED APPLICATIONS

This application is the US National Stage of International Application No. PCT/EP2008/061588, filed Sep. 3, 2007 and claims the benefit thereof. The International Application claims the benefits of Great Britain application No. 0718861.8 GB filed Sep. 27, 2007. All of the applications are incorporated by reference herein in their entirety.

### FIELD OF INVENTION

This invention relates to an apparatus for damping the torsional excitation of a hollow drive shaft.

### BACKGROUND OF INVENTION

It is known to design drive shafts such that their critical speeds (the speeds at which they resonate) do not coincide with the speeds of operation of the equipment being driven. This helps avoid torsional excitation of the drive shaft. It is not always possible to so design a drive shaft. Further, torsional excitation of a drive shaft may occur due to operation of other equipment not driven by the drive shaft but in the same vicinity. Torsional excitation of a drive shaft may also occur due to operation of equipment connected to the equipment being driven, e.g. connected by an electrical circuit. This is especially so since the advent of high powered electronic control equipment utilising thyristors.

When a drive shaft is not robust enough to cope with the torsional excitation it experiences, this is dealt with by: increasing the robustness of the drive shaft; reducing the magnitude of the torsional stresses applied to the drive shaft; and damping the torsional excitation of the drive shaft itself. The present invention relates to the last of these three alternatives.

WO-2005/121594-A2 discloses an apparatus for damping the torsional excitation of a drive shaft.

### SUMMARY OF INVENTION

According to the present invention there is provided an apparatus for damping the torsional excitation of a hollow drive shaft, the apparatus comprising: an elongate member that extends along the interior of the drive shaft, one end of the member being secured to one end of the drive shaft, the other end of the member being disposed at the other end of the drive shaft; and a hydraulic damping device secured to the other end of the drive shaft for damping vibration of the other end of the member, the hydraulic damping device including: a piston and cylinder arrangement having first and second hydraulic chambers; a reservoir of hydraulic fluid; and hydraulic circuitry by means of which the hydraulic chambers communicate with the reservoir of hydraulic fluid, wherein the hydraulic damping device is arranged so that any leakage of hydraulic fluid from the first and second hydraulic chambers via a piston/cylinder interface passes to the reservoir of hydraulic fluid.

In an apparatus according to the preceding paragraph, it is preferable that the piston and cylinder arrangement includes a piston located in a wall of the reservoir.

In an apparatus according to the preceding paragraph, it is preferable that an actuation lever extends radially outwardly from the elongate member at the other end of the member, the lever acting upon the piston.

In an apparatus according to the preceding paragraph, it is preferable that a pair of actuation levers extend radially outwardly from the elongate member at the other end of the member, the levers being located on opposite sides of the member, and the hydraulic damping device comprises: first and second piston and cylinder arrangements, one lever acting upon the first piston and cylinder arrangement, the other lever acting upon the second piston and cylinder arrangement, the first piston and cylinder arrangement extending in a line of vibration of the one lever, the second piston and cylinder arrangement extending in a line of vibration of the other lever; and hydraulic circuitry by means of which the first and second hydraulic chambers of the piston and cylinder arrangements communicate with the reservoir of hydraulic fluid.

In an apparatus according to the preceding paragraph, it is preferable that each piston and cylinder arrangement comprises a single cylinder containing a single piston, each piston being positioned along its cylinder so as to form at either end of the cylinder the first and second hydraulic chambers of the piston and cylinder arrangement.

In an apparatus according to the preceding paragraph, it is preferable that the hydraulic circuitry comprises first and second sections, each section comprising first and second branches connected in parallel, one branch comprising a flow restrictor, the other branch comprising a check valve that permits flow only in a direction away from the reservoir, the first section being connected between the reservoir and both the first hydraulic chamber of the first piston and cylinder arrangement and the diagonally opposite second hydraulic chamber of the second piston and cylinder arrangement, the second section being connected between the reservoir and both the second hydraulic chamber of the first piston and cylinder arrangement and the diagonally opposite first hydraulic chamber of the second piston and cylinder arrangement.

In an apparatus according to the preceding paragraph but two, it is preferable that the first piston and cylinder arrangement comprises a first pair of piston and cylinder assemblies disposed opposite one another in the line of vibration of the one actuation lever, the pistons of the first pair of assemblies bearing against opposite sides of the one lever, and the second piston and cylinder arrangement comprises a second pair of piston and cylinder assemblies disposed opposite one another in the line of vibration of the other actuation lever, the pistons of the second pair of assemblies bearing against opposite sides of the other lever.

In an apparatus according to the preceding paragraph, it is preferable that each piston and cylinder assembly contains a spring located in its hydraulic chamber that biases its piston against an actuation lever, and the piston of each assembly contains therein a flow restrictor and a check valve connected in parallel that communicate between the hydraulic chamber of the assembly and the reservoir of hydraulic fluid, the check valve permitting fluid flow only in a direction away from the reservoir.

In an apparatus according to either of the preceding two paragraphs, it is preferable that the piston of each piston and cylinder assembly includes an actuator awl that extends from the piston generally radially outwardly, the radially outer end of each actuator arm bearing against a side of an actuation lever.

In an apparatus according to any one of the preceding six paragraphs, it is preferable that the reservoir of hydraulic fluid extends around the elongate member and the pair of actuation levers.

In an apparatus according to the preceding paragraph, it is preferable that a spring loaded piston located adjacent the hydraulic damping device and on the axis of rotation of the drive shaft pressurises the reservoir of hydraulic fluid.

### BRIEF DESCRIPTION OF THE DRAWINGS

The invention will now be described, by way of example, with reference to the accompanying drawings, in which:

FIG. 1 is a longitudinal cross section through a hollow drive shaft and an apparatus in accordance with the present invention;

FIG. 2 is a cross section on the line II-II in FIG. 1;

FIG. 3 illustrates an alternative to that shown in FIG. 2;

FIG. 4 illustrates in greater detail a piston and cylinder assembly used in FIG. 3; and

FIG. 5 illustrates a modification to that shown in FIG. 3.

### DETAILED DESCRIPTION OF INVENTION

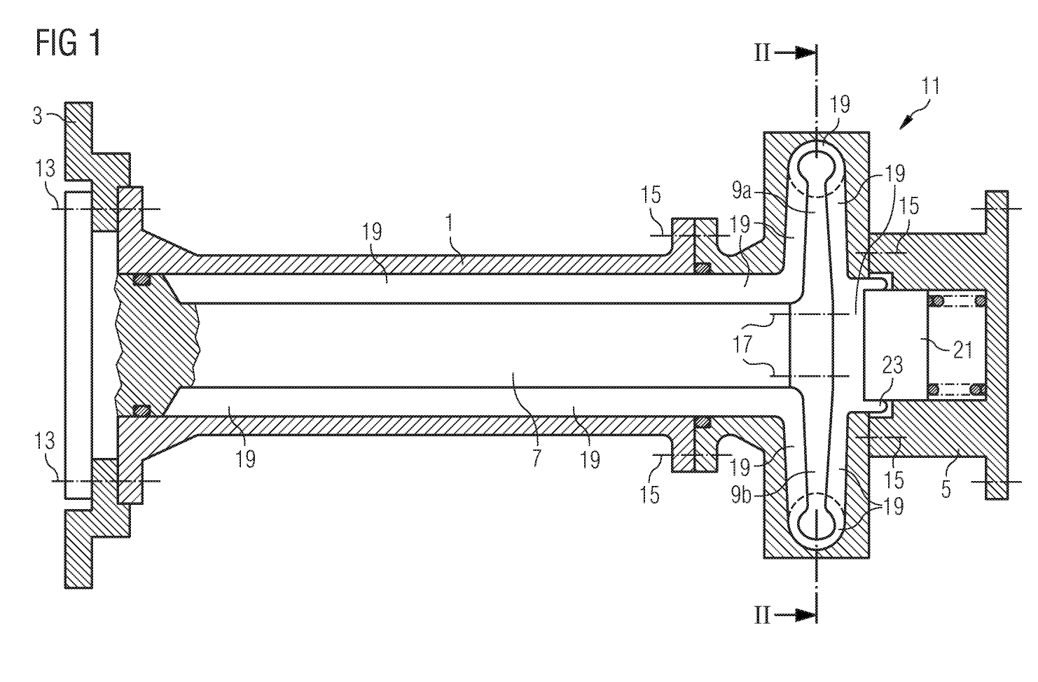

Referring to FIG. 1, a hollow drive shaft 1 is driven by a driver 3, and drives a driven unit 5. The apparatus in accordance with the present invention comprises a torsionally stiff solid cylindrical transfer member 7 concentric with shaft 1, a pair of actuation levers 9a, 9b, and a hydraulic damping device 11. Damping device 11 is connected between shaft 1 and driven unit 5. Driver 3 is connected to shaft 1 by fixings 13, damping device 11 is connected between shaft 1 and driven unit 5 by fixings 15, and actuation levers 9a, 9b are connected to transfer member 7 by fixings 17. Fixings 13 also secure one end of member 7 to the end of shaft 1 connected to driver 3. Member 7 extends along the interior of hollow shaft 1. Levers 9a, 9b are located at the end of member 7 remote from the securing of member 7 to shaft 1, and extend radially outwardly from member 7 spaced 180 degrees apart. Levers 9a, 9b extend so as to communicate with hydraulic damping device 11. The precise nature of this communication will be described below. A pressurised hydraulic fluid reservoir 19 is maintained around member 7 and levers 9a, 9b. The fluid is pressurised by a spring loaded piston 21 located in driven unit 5. Piston 21 communicates with reservoir 19 via a rolling diaphragm 23.

An oscillating twist in shaft 1 due to torsional excitation of shaft 1 results in corresponding relative rotary movement between levers 9a, 9b and damping device 11. For example, take the instance where the driven unit end of shaft 1 is twisted clockwise, and consequently the driver end of shaft 1 is twisted anti-clockwise. The clockwise twisting of the driven unit end causes a corresponding clockwise twist of damping device 11 connected to this end, and the anti-clockwise twisting of the driver end causes a corresponding anti-clockwise twist of transfer member 7 secured to this end and hence a corresponding anti-clockwise twist of levers 9a, 9b. The relative angular position of damping device 11 and levers 9a, 9b corresponds to the twist at that instant of shaft 1.

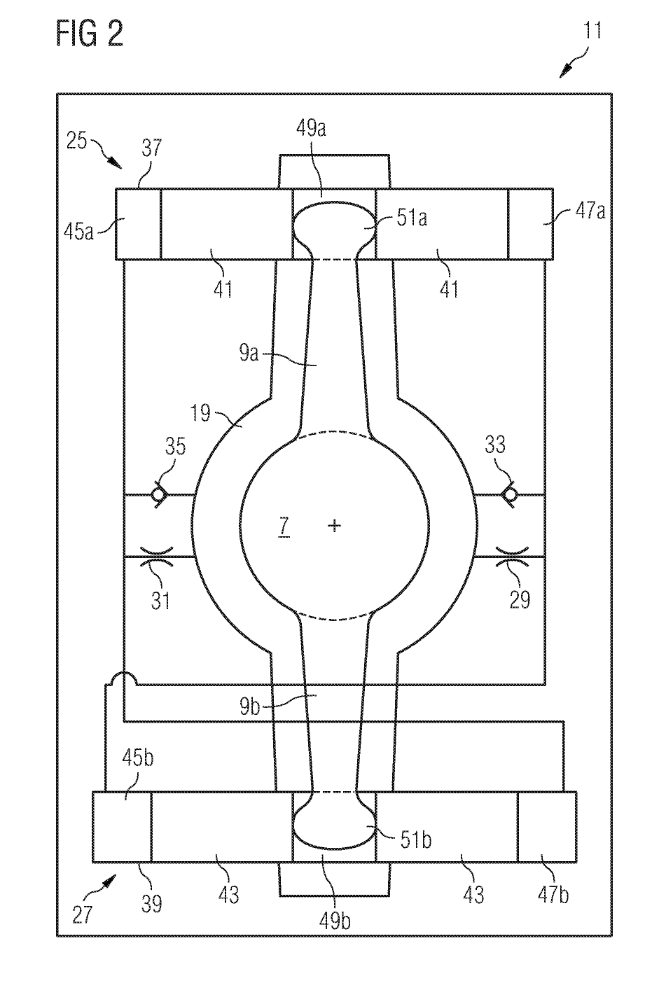

Referring also to FIG. 2, hydraulic damping device 11 comprises first and second piston and cylinder arrangements 25, 27, pressurised hydraulic fluid reservoir 19, first and second restrictor orifices 29, 31, and first and second check valves 33, 35.

Each of the first and second piston and cylinder arrangements 25, 27 comprises a single cylinder 37, 39 containing a single piston 41, 43. Each piston 41, 43 is positioned generally centrally along its cylinder 37, 39 so as to form at either end of the cylinder 37, 39 first and second hydraulic chambers 45a, 45b, 47a, 47b. A slot 49a, 49b is cut centrally along each piston 41, 43 to receive an end 51a, 51b of a corresponding actuation lever 9a, 9b. Each piston and cylinder arrangement 25, 27 extends in the line of vibration of the end 51a, 51b of its corresponding lever 9a, 9b.

The fluid flow path between diagonally opposite hydraulic chambers 45a, 47b and pressurised reservoir 19 comprises first and second branches connected in parallel, one branch comprising restrictor orifice 31, the other branch comprising check valve 35. Similarly, the fluid flow path between diagonally opposite chambers 47a, 45b and reservoir 19 comprises first and second branches connected in parallel, one branch comprising restrictor orifice 29, the other branch comprising check valve 33. Restrictor orifices 29, 31 are designed so that the flow therethrough is laminar. Check valves 33, 35 permit fluid flow only in a direction away from reservoir 19. Check valves 33, 35 are designed so as to be low pressure drop and fast response.

The operation of hydraulic damping device 11 is as follows.

With particular reference to FIG. 2, if, due to torsional excitation of drive shaft 1, actuation levers 9a, 9b rotate in a clockwise direction, then this forces to the right piston 41 of piston and cylinder arrangement 25, and to the left piston 43 of piston and cylinder arrangement 27. This reduces the size of hydraulic chambers 47a, 45b, displacing fluid out of chambers 47a, 45b. The displaced fluid passes via restrictor orifice 29 into pressurised reservoir 19 (note check valve 33 permits flow only in a direction away from reservoir 19). Due to the flow into reservoir 19 and that reservoir 19 is pressurised, fluid also leaves reservoir 19. It crosses check valve 35 to reach hydraulic chambers 45a, 47b. The pressure difference across both first pair of chambers 45a, 47a and second pair of chambers 45b, 47b equals the pressure difference across restrictor orifice 29, and is proportional to the torque opposing the angular twist of shaft 1. As the flow across restrictor orifice 29 is dependent upon the angular twist velocity of shaft 1, a true damping torque is produced which is proportional to the angular twist velocity. Provided laminar flow is maintained across restrictor orifice 29, the damping is purely linear and viscous in nature.

If torsional excitation of shaft 1 causes levers 9a, 9b to rotate in an anti-clockwise direction, then operation of the hydraulic damping circuit is as before, but in reverse. Thus, fluid leaves chambers 45a, 47b, crosses restrictor orifice 31, enters and leaves reservoir 19, crosses check valve 33, and enters chambers 47a, 45b. In this case, the pressure difference across both first pair of chambers 45a, 47a and second pair of chambers 45b, 47b equals the pressure difference across restrictor orifice 31.

If the dynamics of the overall system are well defined, then restrictor orifices 29, 31 may be of fixed restriction, i.e. variation of their restriction not possible. This saves cost. However, in a less well defined system, variable laminar orifices may be used to provide adjustable damping. The level of damping would then be adjusted to suit actual running conditions.

Hydraulic systems over the course of their operating life may suffer loss of incompressibility due to the formation of gas/air bubbles. This is of little consequence in many hydraulic systems, but in the case of the above described system may well result in inoperability, since an instantaneous damping torque is required in response to very small angular displacements. Gas/air bubbles form due to cavitation in the hydraulic fluid, i.e. negative pressure in the hydraulic fluid which results in the gas/air normally present in a hydraulic fluid coming out of solution to form gas/air bubbles. Cavitation typically occurs when a hydraulic fluid is drawn into a chamber by expansion of the chamber. In the above described system, cavitation is prevented by the use of: (i) pressurised reservoir 19; and (ii) check valves 33, 35 in parallel with restrictor orifices 29, 31 (the check valves allow hydraulic fluid to bypass the restrictor orifices when flowing to a chamber 45a, 47a, 45b, 47b, thereby enabling a fast response to an expanding chamber 45a, 47a, 45b, 47b ).

It is to be noted that pressurised reservoir 19 compensates for volume fluctuations within the hydraulic circuit. Such fluctuations might occur due to: wear (e.g. at the contact surfaces where ends 51a, 51b of actuation levers 9a, 9b abut pistons 41, 43), temperature change, and hydraulic fluid leakage.

It is to be noted that any hydraulic fluid leakage from chambers 45a, 47a, 45b, 47b via the interfaces between pistons 41, 43 and cylinders 37, 39 will pass to reservoir 19, therefore remaining in the closed hydraulic circuit and not harming operation.

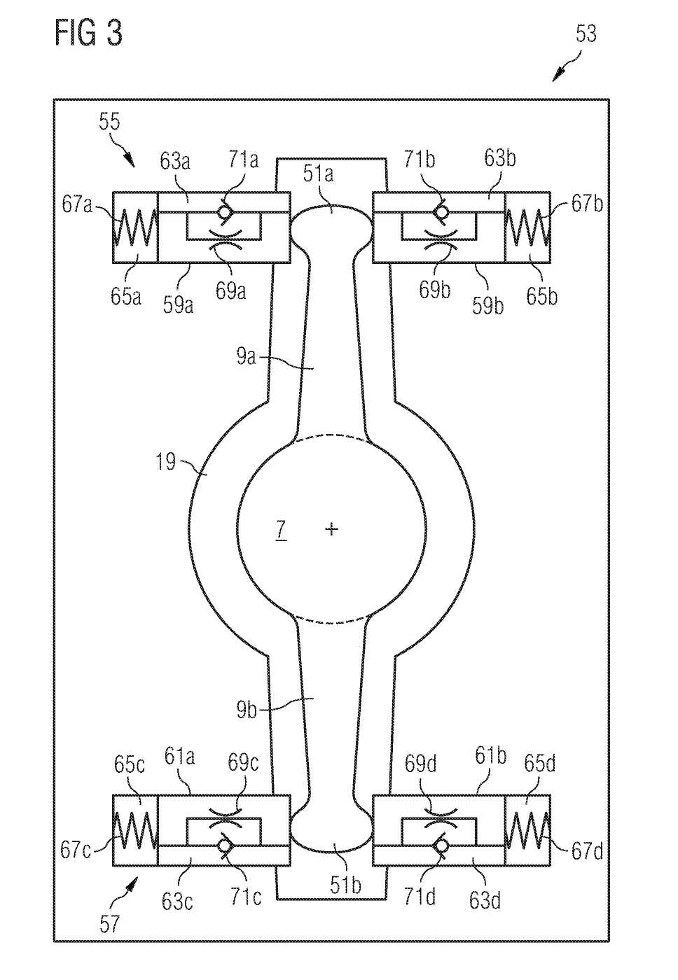

The alternative hydraulic damping device 53 shown in FIG. 3 comprises first and second piston and cylinder arrangements 55, 57, and pressurised hydraulic fluid reservoir 19 (as reservoir 19 in FIG. 2). The first arrangement 55 comprises a pair of piston and cylinder assemblies 59a, 59b disposed opposite one another in the line of vibration of end 51a of actuator lever 9a, the pistons of assemblies 59a, 59b bearing against opposite sides of end 51a. Similarly, the second piston and cylinder arrangement 57 comprises a pair of piston and cylinder assemblies 61a, 61b disposed opposite one another in the line of vibration of end 51b of actuator lever 9b, the pistons of assemblies 61a, 61b bearing against opposite sides of end 51b. Each piston and cylinder assembly 59a, 59b, 61a, 61b comprises a piston 63a, 63b, 63c, 63d, a hydraulic chamber 65a, 65b, 65c, 65d, a spring 67a, 67b, 67c, 67d, a restrictor orifice 69a, 69b, 69c , 69d, and a check valve 71a, 71b, 71c, 71d. Each spring 67a, 67b, 67c, 67d is located in a respective chamber 65a, 65b, 65c, 65d, and biases a respective piston 63a, 63b, 63c, 63d against a side of an end 51a, 51b of an actuator lever 9a, 9b (it is to be noted here that this arrangement will self adjust for any wear of ends 51a, 51b ). Each piston 63a, 63b, 63c, 63d contains a restrictor orifice 69a, 69b, 69c, 69d and a check valve 71a, 71b, 71c, 71d connected in parallel. The restrictor orifices 69a, 69b, 69c, 69d and check valves 71a, 71b, 71c, 71d communicate between chambers 65a, 65b, 65c, 65d and pressurised reservoir 19. Each check valve 71a, 71b, 71c, 71d permits fluid flow only in a direction away from reservoir 19.

The operation of hydraulic damping device 53 is as follows.

If, due to torsional excitation of drive shaft 1, actuation levers 9a, 9b rotate in a clockwise direction, then this forces to the right piston 63b of piston and cylinder assembly 59b, and to the left piston 63c of piston and cylinder assembly 59c. This reduces the size of hydraulic chambers 65b, 65c, displacing fluid out of chambers 65b, 65c. The displaced fluid passes via restrictor orifices 69b, 69c into pressurised reservoir 19 (note check valves 71b, 71c permit flow only in a direction away from reservoir 19). Due to the flow into reservoir 19 and that reservoir 19 is pressurised, fluid also leaves reservoir 19. It crosses check valves 71a, 71d to reach hydraulic chambers 65a, 65d. The pressure difference across both pair of chambers 65a, 65b and pair of chambers 65c, 65d equals the pressure difference across restrictor orifices 69b, 69c and is proportional to the torque opposing the angular twist of shaft 1. As the flow across restrictor orifices 69b, 69c is dependent upon the angular twist velocity of shaft 1, a true damping torque is produced which is proportional to the angular twist velocity. Provided laminar flow is maintained across restrictor orifices 69b, 69c, the damping is purely linear and viscous in nature.

If torsional excitation of shaft 1 causes levers 9a, 9b to rotate in an anti-clockwise direction, then operation of the hydraulic damping circuit is as before, but in reverse. Thus, fluid leaves chambers 65a, 65d, crosses restrictor orifices 69a, 69d, enters and leaves reservoir 19, crosses check valves 71b, 71c, and enters chambers 65b, 65c. In this case, the pressure difference across both pair of chambers 65a, 65b and pair of chambers 65c, 65d equals the pressure difference across restrictor orifices 69a, 69d.

Similarly to the hydraulic damping device of FIG. 2, any hydraulic fluid leakage from chambers 65a, 65b, 65c, 65d via the interfaces between pistons 63a, 63b, 63c, 63d and their cylinders will pass to reservoir 19, therefore remaining in the closed hydraulic circuit and not harming operation.

In the hydraulic damping device of FIG. 3, the required restrictor orifices and check valves are located internally of the first and second piston and cylinder arrangements 55, 57. This is to simplify manufacture, and is to be contrasted to the hydraulic damping device of FIG. 2 wherein the restrictor orifices and check valves are located externally of the first and second piston and cylinder arrangements 25, 27.

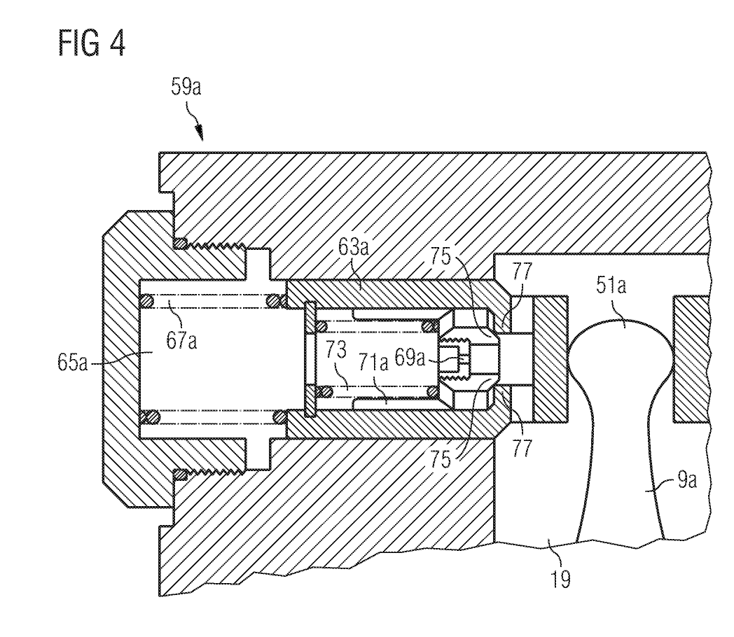

FIG. 4 illustrates in greater detail the structure of piston and cylinder assembly 59a. The structure of piston and cylinder assemblies 59b, 61 a, 61b is the same. If end 51a of actuation lever 9a moves to the right, this allows piston 63a to move to the right under the action of spring 67a. This creates a pressure drop between reservoir 19 and chamber 65a that moves to the left, against the action of spring 73 of check valve 71a, cone end 75 of check valve 71a. This unseats cone end 75 from mating annulus 77 of piston 63a, opening valve 71a, and allowing fluid to pass to chamber 65a. If end 51a of actuation lever 9a moves to the left, this compresses springs 67a and 73, reducing the size of chamber 65a, and causing fluid to pass from chamber 65a via restrictor orifice 69a to reservoir 19. It is to be noted that whether end 51 a moves to the right or left, the head of piston 63a always remains biased against end 51a due to the action of spring 67a.

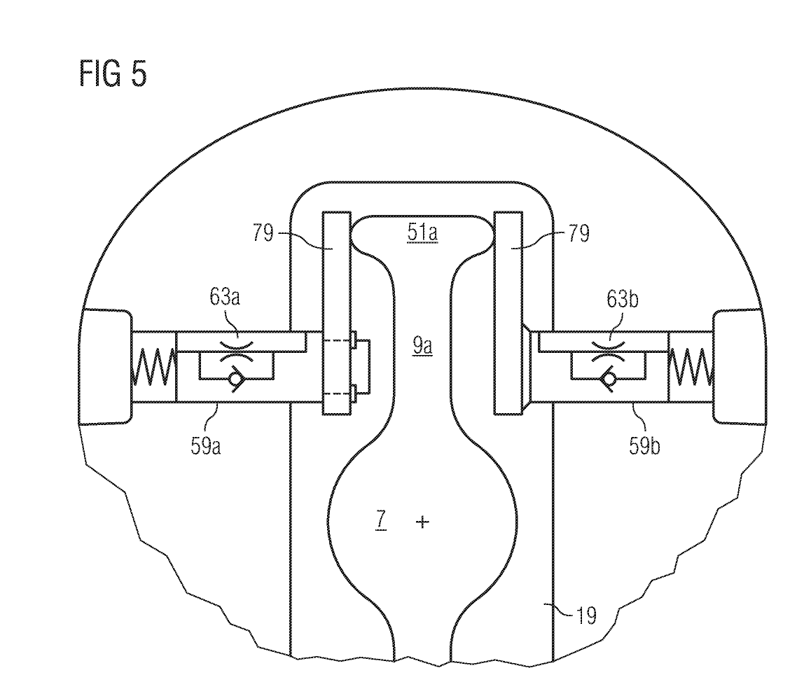

The hydraulic damping device of FIG. 5 is the same as that of FIG. 3 with the exception that actuator arms 79 have been added to pistons 63a, 63b, 63c, 63d, and pressurised reservoir 19 has been reshaped to be generally rectangular. This enables piston and cylinder assemblies 59a, 59b, 61a, 61b to be moved inward, providing a more compact, overall circular hydraulic damping device.

1.-11. (canceled)

12. An apparatus for damping the torsional excitation of a hollow drive shaft, the apparatus comprising:
an elongate member that extends along an interior of the drive shaft, a first end of the elongate member is secured to a first end of the drive shaft, a second end of the elongate member is disposed at a second end of the drive shaft; and
a hydraulic damping device secured to the second end of the drive shaft for damping vibration of the second end of the elongate member, the hydraulic damping device comprising:
a piston and cylinder arrangement including first and second hydraulic chambers,
a reservoir of hydraulic fluid, and
hydraulic circuitry of which the hydraulic chambers communicate with the reservoir of hydraulic fluid,
wherein the hydraulic damping device is arranged so that any leakage of a hydraulic fluid from the first and second hydraulic chambers via a piston/cylinder interface passes to the reservoir of hydraulic fluid.

13. The apparatus as claimed in claim 12, wherein the piston and cylinder arrangement includes a piston located in a wall of the reservoir.

14. The apparatus according to claim 13,
wherein an actuation lever extends radially outwardly from the elongate member at the second end of the elongate member, and
wherein the actuation lever acts upon the piston.

15. An apparatus for damping the torsional excitation of a hollow drive shaft, the apparatus comprising:
an elongate member that extends along an interior of the drive shaft, a first end of the elongate member is secured to a first end of the drive shaft, a second end of the elongate member is disposed at a second end of the drive shaft; and
a hydraulic damping device secured to the second end of the drive shaft for damping vibration of the second end of the elongate member, the hydraulic damping device comprising:
a first and second piston and cylinder arrangement each including first and second hydraulic chambers,
a reservoir of hydraulic fluid, and
hydraulic circuitry of which the hydraulic chambers communicate with the reservoir of hydraulic fluid,
wherein the hydraulic damping device is arranged so that any leakage of a hydraulic fluid from the first and second hydraulic chambers via a piston/cylinder interface passes to the reservoir of hydraulic fluid,
wherein the first and second piston and cylinder arrangements each include a piston located in a wall of the reservoir,
wherein a pair of actuation levers, a first actuation lever and a second actuation lever, extend radially outwardly from the elongate member at the second end of the elongate member,
wherein the pair of actuation levers are located on opposite sides of the elongate member,
wherein the first actuation lever acts upon the first piston and cylinder arrangement, the second actuation lever acts upon the second piston and cylinder arrangement, the first piston and cylinder arrangement extends in a first line of vibration of the first actuation lever, the second piston and cylinder arrangement extends in a second line of vibration of the second actuation lever, and
wherein the hydraulic circuitry uses the first and second hydraulic chambers of each of the piston and cylinder arrangements to communicate with the reservoir of hydraulic fluid.

16. The apparatus as claimed in claim 15,
wherein each piston and cylinder arrangement comprises a single cylinder containing a single piston, and
wherein each piston is positioned along the corresponding cylinder forming at either end of the cylinder the first and second hydraulic chambers of the piston and cylinder arrangement.

17. The apparatus as claimed in claim 16,
wherein the hydraulic circuitry further comprises a first section and a second section, each section comprising a first branch and a second branch connected in parallel, the first branch comprising a flow restrictor, the second branch comprising a check valve that permits flow only in a direction away from the reservoir,
wherein the first section is connected between the reservoir and both the first hydraulic chamber of the first piston and cylinder arrangement and the diagonally opposite second hydraulic chamber of the second piston and cylinder arrangement, and
wherein the second section is connected between the reservoir and both the second hydraulic chamber of the first piston and cylinder arrangement and the diagonally opposite first hydraulic chamber of the second piston and cylinder arrangement.

18. The apparatus as claimed in claim 17, wherein the reservoir of hydraulic fluid extends around the elongate member and the pair of actuation levers.

19. The apparatus as claimed in claim 18, wherein a spring loaded piston located adjacent the hydraulic damping device and on an axis of rotation of the drive shaft pressurises the reservoir of hydraulic fluid.

20. The apparatus according to claim 15,
wherein the first piston and cylinder arrangement comprises a first pair of piston and cylinder assemblies disposed opposite one another in the line of vibration of the first actuation lever,
wherein a first plurality of pistons of the first pair of assemblies bears against opposite sides of the first actuation lever, and
wherein the second piston and cylinder arrangement comprises a second pair of piston and cylinder assemblies disposed opposite one another in the line of vibration of the second actuation lever, and
wherein a second plurality of pistons of the second pair of assemblies bears against opposite sides of the second actuation lever.

21. The apparatus as claimed in claim 20,
wherein each piston and cylinder assembly comprises a spring located in the corresponding hydraulic chamber that biases the corresponding piston against an actuation lever, and
wherein the piston of each piston and cylinder assembly comprises a flow restrictor and a check valve connected in parallel that communicates between the hydraulic chamber of the assembly and the reservoir of hydraulic fluid, the check valve permitting fluid flow only in a direction away from the reservoir.

22. The apparatus as claimed in claim 21, wherein the piston of each piston and cylinder assembly includes an actuator arm that extends from the piston generally radially outwardly, a radially outer end of each actuator arm bearing against a side of an actuation lever.

23. The apparatus as claimed in claim 22, wherein the reservoir of hydraulic fluid extends around the elongate member and the pair of actuation levers.

24. The apparatus as claimed in claim 23, wherein the spring loaded piston located adjacent the hydraulic damping device and on the axis of rotation of the drive shaft pressurises the reservoir of hydraulic fluid.

25. The apparatus as claimed in claim 15, wherein the reservoir of hydraulic fluid extends around the elongate member and the pair of actuation levers.

26. The apparatus as claimed in claim 21, wherein the spring loaded piston located adjacent the hydraulic damping device and on the axis of rotation of the drive shaft pressurises the reservoir of hydraulic fluid.
